(19) United States
(12) Patent Application Publication
(10) Pub. No.: US 2011/0279338 A1
(43) Pub. Date: Nov. 17, 2011

(54) TRIPLE-BAND ANTENNA AND METHOD OF MANUFACTURE

(75) Inventors: Jorge Myszne, San Jose, CA (US); Ofer Markish, Emek Hefer (IL)

(73) Assignee: WILOCITY, LTD., Caesarea (IL)

(21) Appl. No.: 13/052,736

(22) Filed: Mar. 21, 2011

Related U.S. Application Data
(60) Provisional application No. 61/333,957, filed on May 12, 2010.

(51) Int. Cl. H01Q 21/30; H01P 11/00

(52) U.S. Cl. 343/725; 29/600

(57) ABSTRACT

A triple-band antenna for transmitting and receiving low-frequency band signals and high-frequency band signals. The triple-band antenna includes a printed antenna having two wings for transmitting and receiving low-frequency signals; and an antenna array including a plurality of radiating elements being printed on one of the wings of the printed antenna, wherein the antenna array transmits and receives the high-frequency band signals, wherein one of the wings of the printed dipole is a ground for the antenna array.

### CROSS-REFERENCE TO RELATED APPLICATIONS

This application claims the benefit of U.S. provisional application No. 61/333,957 filed on May 12, 2010, the contents of which are herein incorporated by reference.

### TECHNICAL FIELD

The present invention relates generally to antennas for portable wireless communication devices, and particularly to triple-band antennas.

### BACKGROUND OF THE INVENTION

The 60 GHz band is an unlicensed band which features a large amount of bandwidth and a large worldwide overlap. The large bandwidth means that a very high volume of information can be transmitted wirelessly. As a result, multiple applications, that require transmission of a large amount of data, can be developed to allow wireless communication around the 60 GHz band. Examples for such applications include, but are not limited to, wireless high definition TV (HDTV), wireless docking station, wireless Gigabit Ethernet, and many others.

The objective of the industry is to integrate 60 GHz band applications with portable devices including, but not limited to, netbook computers, tablet computers, smart phones, laptop computers, and the like. The physical size of such devices is relatively small, thus the area for installing additional circuitry to support 60 GHz applications is limited. For example, an assembly of a lid of a laptop or netbook computer typically includes a cellular antenna to communicate with a cellular network, a Wi-Fi antenna to receive and transmit signals from an access point of a wireless network, and a webcam. To support communication in the 60 GHz band, active antennas should be also assembled in the lid. To avoid problems of signal interferences, the various antennas should be positioned at a predefined distance from each other.

In order to save space, portable devices are now designed with a dual band Wi-Fi antenna that operates in the frequency bands of 2.4 GHx and 5 GHz. One example for such an antenna is a dipole printed antenna as schematically shown in FIG. 1. The antenna 100 includes two printed dipole strips 110 (hereinafter wings) and an electrical transmission line 120 that acts as an unbalanced-to-balanced transformer between a feed coaxial line 130 and the two printed dipole strips 110. The total length of a dipole strip is approximately a ¼ wavelength of a signal at 2.4 GHz. The electrical line 120 and the dipole strips 110 are printed on the same plane and fabricated on the same substructure. The physical dimensions of the antenna 100 are a function of the wavelength of the low frequency band (e.g., 2.4 GHz). For example, based on the specific implementation, the dimension of a dual band printed antenna is L×W=60×10 mm². Trying to support a 60 GHz band using a conventional dipole antenna, such as shown in FIG. 1, is not feasible as the antenna gain would be too low in order to enable efficient transmission and reception of radio frequency signals.

Therefore, it would be advantageous to provide a triple-band antenna that is versatile and can provide high performance in a compact size for both low and high frequency bands.

### SUMMARY OF THE INVENTION

Certain embodiments disclosed herein include a triple-band antenna for transmitting and receiving low-frequency band signals and high-frequency band signals. The triple-band antenna includes a printed antenna having two wings for transmitting and receiving low-frequency signals; and an antenna array including a plurality of radiating elements being printed on one of the wings of the printed antenna, wherein the antenna array transmits and receives the high-frequency band signals, wherein the one of the wings is a ground for the antenna array.

Certain embodiments disclosed herein also include a method for manufacturing a triple-band antenna. The method includes printing, using a fabrication process, a dipole antenna having two wings; connecting a first feed wire at a connecting point of the two wings using a connector; suspending an array of a plurality of radiating elements over one of the wings; connecting each radiating element to a second feed wire and a radio frequency integrated circuit (RFIC) high-frequency band transceiver; grounding each of the second feed wire to the one of the wings; and mounting the resulted structure on an insulated board.

### BRIEF DESCRIPTION OF THE DRAWINGS

Various embodiments are particularly pointed out and distinctly claimed in the claims at the conclusion of the specification. The foregoing and other objects, features, and advantages of the invention will be apparent from the following detailed description taken in conjunction with the accompanying drawings.

FIG. 1 is a diagram of an on-chip dipole antenna;

FIG. 2 is a schematic diagram of a triple-band antenna constructed in accordance with an embodiment of the invention;

FIG. 3 is an exemplary and non-limiting diagram showing a connection of a radiating element of a phase array antenna to a wing of a printed dipole antenna;

FIG. 4 shows an embodiment of the invention for mounting a triple-band antenna of an high-frequency band RFIC transceiver onto a board;

FIGS. 5A and 5B depict graphs of return loss varying with frequency results simulated for the triple-band antenna; and

FIG. 6 is a flowchart describing an exemplary manufacturing process of the triple-band antenna.

### DETAILED DESCRIPTION OF THE INVENTION

The embodiments disclosed by the invention are only examples of the many possible advantageous uses and implementations of the innovative teachings presented herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

FIG. 2 shows a schematic diagram of a triple-band antenna 200 constructed in accordance with an embodiment of the invention. The antenna 200 is designed to receive and transmit radio frequency (RF) signals at three different frequency bands. In accordance with an embodiment of the invention, these bands include, but are not limited to 60 GHz, 2.4 GHz, and 5 GHz, thereby supporting applications in both the Wi-Fi and 60 GHz bands.

The triple-band antenna 200 is installed on an insulated board 230 of a portable wireless device. Such device may include, but is not limited to, a smart phone, a personal digital assistant (PDA), a laptop computer, a netbook computer, a tablet computer, and the like.

The triple-band antenna 200 includes a printed dipole having two wings 210-1 and 210-2 and a phase array 220 fabricated on the same substrate. Specifically, the one printed dipole's wing (e.g., 210-1) serves as a ground to a phase array antenna. The other wing (210-2) is shaped to provide the radiating elements for signals transmitted or received in the 2.4 GHz and 5 GHz frequency bands. A feed line 240, which may be a coaxial line or other suitable radio-frequency signal path structure, is connected to the printed dipole (wings 210-1, 210-2) using a connector 250. The connector 250 may be a mini micro coaxial connector (UFL) connector or other suitable attachment structure.

The phase array 220 is the 60 GHz antenna and, in one embodiment of the invention, is based on a patch antenna. Specifically, the substrate of the phase array 220 consists of N radiating elements 221, each with a phase shifter. For exemplary purposes only and without departing from the scope of the invention, only one radiating element 221 is labeled. Beams are formed by shifting the phase of the signal emitted from each radiating element. The ground of the phase array 220 is one of the wings of the printed dipole 210, e.g., wing 210-1. In accordance with an exemplary embodiment of the invention, the tripe-band antenna may be implemented with antenna array that are not of a phased array antenna.

The physical dimensions of the triple-band antenna 200 are based on the low frequency band. The length of each wing is λ\4, where λ is a wavelength of a low frequency band signal being transmitted (e.g., 2.4 GHz). The low frequency band (e.g., 2.4 GHz or 5 GHz) can operate concurrently and without interfering with the high frequency band (e.g., 60 GHz), as the wing of the low band serves as the ground for the high band. It should be noted that the beam of the 60 GHz band signal outputted by the phase array 220 is narrow, thus when the beam is emitted from the wing 210-1, the radiating element of the wing 210-2 does not interrupt the reception of the signal. On the other hand, for the printed dipole, the phase array patches and any circuitry installed thereon are just areas where the metal is thicker, and as such the dipole's properties are not affected.

In an embodiment of the invention, one of the dipole wings can be curled in order to fit to the dimensions of the board on which the antenna is printed. In another exemplary embodiment of the invention, the number of radiating elements in the phase array 220 is 16 and the physical dimensions of the triple-band antenna 200 are approximately 50 mm by 7 mm.

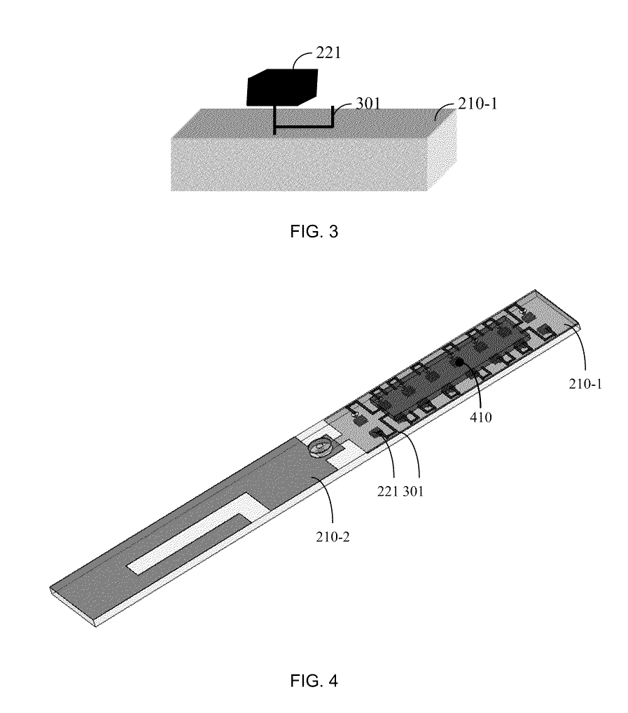

The physical connection of the phase array's radiating elements 221 to the dipole wing 210-1 may be in a form of a patch antenna. That is, each radiating element 221 is suspended over a ground plane, e.g., over the dipole wing 210-1. An exemplary and non-limiting diagram showing such connection is provided in FIG. 3.

As illustrated, the feed wire 301, which may be a coaxial line or other suitable radio-frequency signal path structure of the radiating element, connects the radiating element to the ground (wing 210-1) and to a high-frequency band transceiver. For example, an inner conductor of a coaxial line is the connection to transceiver, and a tubular conducting shield is connected to the ground. The frequency band transceiver implements at least the beam forming function of the phase array antenna.

In accordance with another embodiment of the invention, in order to save additional space on the board, the high-frequency band transceiver can be mounted on the triple-band antenna 200. An exemplary diagram of such implementation is shown in FIG. 4. The high-frequency band transceiver 410 is an RF integrated circuit (IC) that transmits and receives RF signals over the 60 GHz frequency band. It should be appreciated that such an implementation allows for shortening the length of the feed wires (or traces) 301 connecting the transceiver 410 to elements 221 of the phase array 220, thereby minimizing the energy lost on such connections.

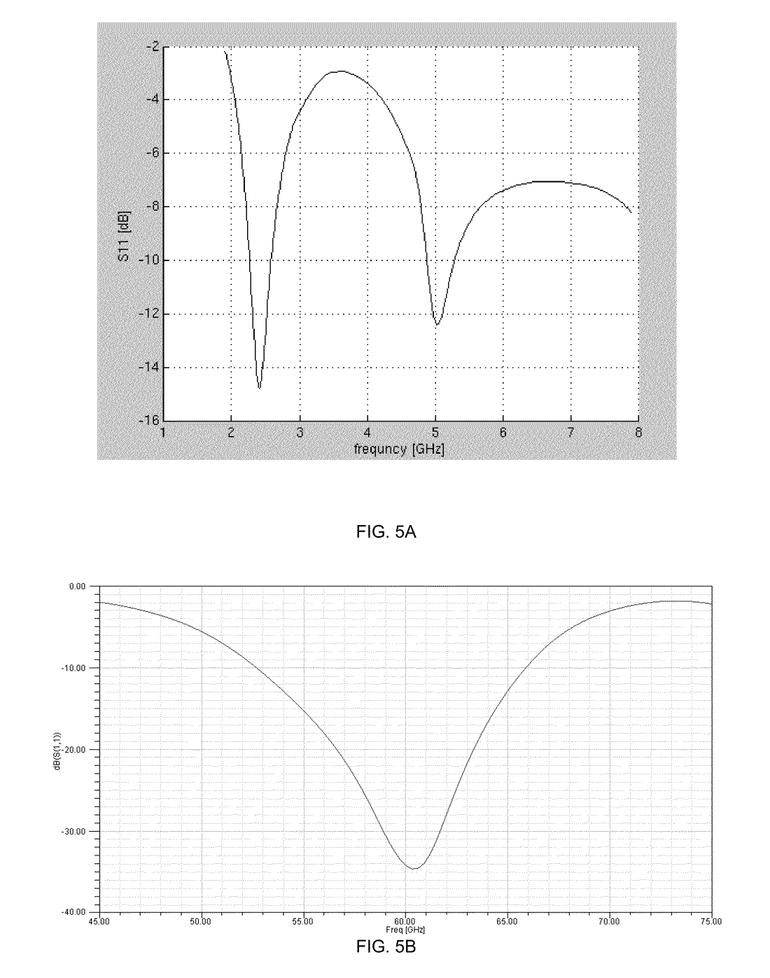

FIGS. 5A and 5B show examples of test result graphs of the return loss varying with frequency as simulated for the triple-band antenna 200. The triple-band antenna 200 generates three resonant frequencies near the frequencies of 2.4 GHz and 5 GHz (FIG. 5A) and the frequency of 60 GHz (FIG. 5B) during the test, respectively. When the return loss (S11) is below −10 db at a given frequency, it is an indication of the operation frequency of the antenna. Therefore, as depicted in FIGS. 5A and 5B the operation frequencies are around 2.4 GHz, 5 GHz, and 60 GHz, respectively. Only for exemplary purposes, the return loss results are shown in two graphs.

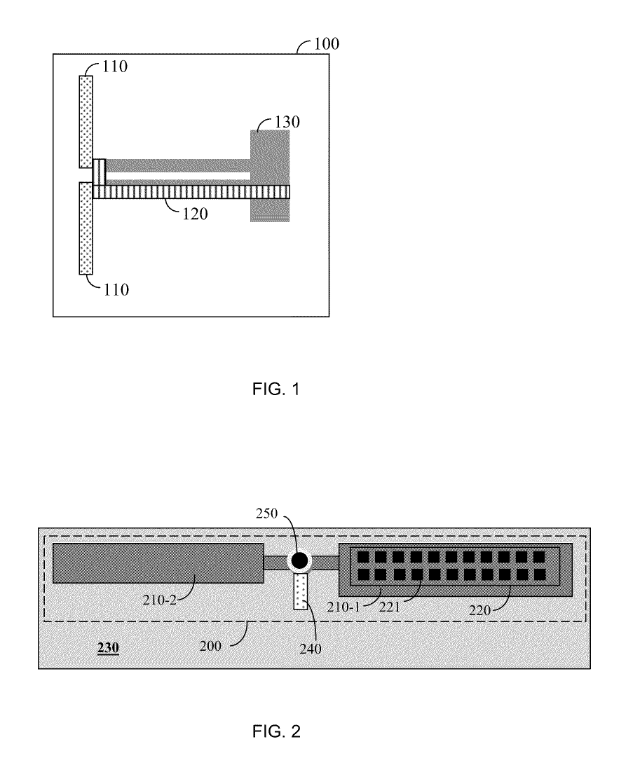

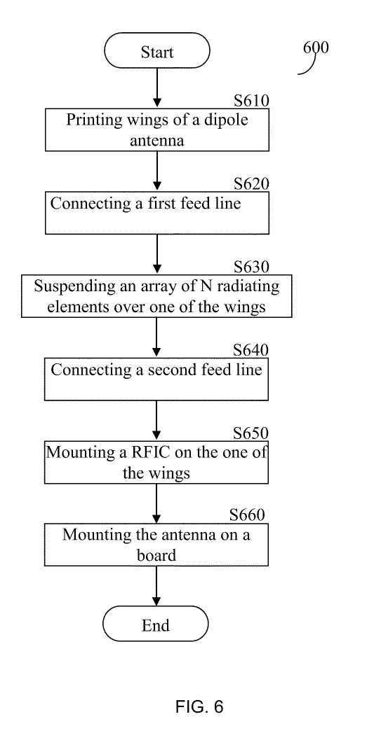

FIG. 6 shows a non-limiting flowchart 600 describing a manufacturing process of the triple-band antenna 200 according to an embodiment of the invention. At S610, two wings in a form of a dipole antenna are printed on a conductive substrate. The printed antenna may be an on-chip dipole antenna shown in FIG. 1. However, according an embodiment of the invention, the dipole strips are the wings, where the length of each wing is a quarter of a wavelength of 2.4 GHZ signal. The wings of the printed dipole can receive and transmit RF signals at frequency bands of 2.4 GHz and 5 GHz. At S620, a first feed wire is connected at a connecting point of the wings using a connector.

At S630, a number of N (N is an integer number greater than 1) radiating elements are fabricated on the same substrate as the printed dipole, where all radiating elements are suspended over one of the wings. At S640, a second feed wire is connected to each of the radiating elements and to a high-frequency band transceiver. Optionally, at S650, an RFIC high-frequency band transceiver, having physical dimensions less than the dimensions of a wing, is mounted over the wing having the array of radiating elements. At S660, the resulted structure is mounted on an insulated board.

It is important to note that these embodiments are only examples of the many advantageous uses of the innovative teachings herein. Specifically, the innovative teachings disclosed herein can be adapted in any type of consumer electronic devices where reception and transmission of millimeter wave signals is needed. Moreover, some statements may apply to some inventive features but not to others. In general, unless otherwise indicated, it is to be understood that singular elements may be in plural and vice versa with no loss of generality.

The manufacturing process disclosed herein can be implemented in hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A triple-band antenna for transmitting and receiving low-frequency band signals and high-frequency band signals, comprising:
a printed antenna having two wings for transmitting and receiving low-frequency band signals; and
an antenna array including a plurality of radiating elements being printed on one of the wings of the printed antenna, wherein the antenna array transmits and receives the high-frequency band signals, wherein one of the wings of the printed antenna is a ground for the antenna array.

2. The triple-band antenna of claim 1 is installed on an insulated board of a wireless device.

3. The triple-band antenna of claim 2, wherein the two wings of the printed antenna are of a printed dipole.

4. The triple-band antenna of claim 3, wherein a length of each wing is a quarter of a wavelength of a low-frequency band signal.

5. The triple-band antenna of claim 4, wherein a frequency the low-frequency band signal is 2.4 GHz.

6. The triple-band antenna of claim 1, wherein the low-frequency signals are at the frequency bands of 2.4 GHz and 5 GHz.

7. The triple-band antenna of claim 1, wherein the high-frequency signals received and transmitted by the antenna array are at the frequency bands of 60 GHz.

8. The triple-band antenna of claim 1, wherein the antenna array is at least a phase array.

9. The triple-band antenna of claim 1, wherein each of the plurality of radiating elements is suspended over one of the wings.

10. The triple-band antenna of claim 9, wherein a feed wire connects each of the plurality of radiating elements to the one of the wings and to a radio frequency integrated circuit (RFIC) high-frequency band transceiver.

11. The triple-band antenna of claim 10, wherein the RFIC high-frequency band transceiver is mounted on the triple-band antenna.

12. The triple-band antenna of claim 11, wherein the wings of the printed antenna are connected to a low-frequency band transceiver through a feed wire and a connector, the feed wire is attached to a connecting point of the two wings.

13. The triple-band antenna of claim 12, wherein the connector is a mini micro coaxial connector (UFL) connector.

14. The triple-band antenna of claim 2, wherein the wireless device is any one of: a laptop computer, a mobile phone, a smart phone, a netbook computer, a tablet computer, and a PDA.

15. A method for manufacturing a triple-band antenna, comprising:
printing, using a fabrication process, a dipole antenna having two wings;
connecting a first feed wire at a connecting point of the two wings using a connector;
suspending an array of a plurality of radiating elements over one of the wings;
connecting each of the plurality of radiating elements to a second feed wire and a radio frequency integrated circuit (RFIC) high-frequency band transceiver;
grounding the second feed wire to the one of the wings; and
mounting a resulting structure of the triple band antenna an insulated board.

16. The method of claim 15, further comprising:
mounting the RFIC high-frequency band transceiver on one of the wings.

17. The method of claim 15, wherein a length of each wing is a quarter of a wavelength of a low-frequency band signal.

18. The method of claim 15, wherein the dipole antenna transmits and receives low-frequency bands signals and the array of the plurality of radiating elements transmits and receives high-frequent band signals.

19. The method of claim 18, wherein the number of radiating elements is 16 and the physical dimensions of the triple-band antenna is 50 mm by 7 mm.
